(19) United States
(12) Patent Application Publication
(10) Pub. No.: US 2015/0019308 A1
(43) Pub. Date: Jan. 15, 2015

(54) Methods and Systems for a Multi-User Competition

(71) Applicant: WRIGHTSIDE SOFTWARE LIMITED, Sydney, New South Wales (AU)

(72) Inventors: Paul Wright, Sydney (AU); Emil Isaac, Kellyville (AU); Johannes Koppensteiner, Taplow (GB); Adam Connor, Drysdale (AU); Tim Ruse, Brunswick West (AU); Scott Vandonkelaar, Lalor (AU); Timothy Alford, Caufield North (AU)

(73) Assignee: WRIGHTSIDE SOFTWARE LIMITED, Sydney, New South Wales (AU)

(21) Appl. No.: 14/377,435

(22) PCT Filed: Feb. 7, 2013
(86) PCT No.: PCT/AU2013/000111

§ 371 Date: Aug. 7, 2014

(30) Foreign Application Priority Data
Feb. 7, 2012 (AU) 2012900439

(51) Int. Cl. G06Q 30/02

(52) U.S. Cl. CPC G06Q 30/0212; G06Q 30/0257
USPC 705/14.14

(57) ABSTRACT

A method of offering a reward customized to a user that is carried out by a processing system, including receiving a user selection of a unique identifier from a plurality of unique identifiers associated with a respective plurality of items from one or more first providers. The method further includes determining an item associated with the user selection, and offering a reward customized to such item.

### FIELD OF THE INVENTION

There is provided herein methods, processes and systems for a competition. In particular, there is provided herein methods and systems for generating a list of potential prize items, providing location information with respect to selected items, associating one or more users with an item, generating customised advertising, and generating a pool of user points.

### BACKGROUND OF THE INVENTION

Typically, a competition includes a number of users competing for one or more prizes, which are well known to those competing. There are currently no competitions where a user can select their own prize to be won, where a user can collect a list of wanted items or prizes and a system directs the user to the prize or where the user receives customised advertising accordingly.

Thus there is required a system and/or method for a competition and/or advertising which overcomes or at least ameliorates one or more disadvantages of existing arrangements, or provides an alternative to existing arrangements.

Any reference herein to known prior art does not, unless the contrary indication appears, constitute an admission that such prior art is commonly known by those skilled in the art to which the invention relates, at the priority date of this application.

### SUMMARY OF THE INVENTION

In one example, there is provided herein a method of offering a reward customised to a user, the method including the steps of, in a processing system: receiving a user selection of a unique identifier from a plurality of unique identifiers associated with a respective plurality of items from one or more first providers; determining the item associated with the user selection; and, offering the reward customised to the item associated with the user selection.

In a further example, the reward can include any one or a combination of: a special offer by the one or more first providers; a chance to win the item; and, a special offer by one or more second providers.

In yet a further example, the method includes: receiving a request from one or, more first providers to connect to one or more second providers; receiving acceptance of the request from the one or more second providers; and connecting the one or more first providers to one or more second providers.

In accordance with another example, the method further includes receiving a list of first provider items from the one or more first providers and receiving a list of second provider items from the one or more second providers, such that the user selection is an item included in the list of first provider items and the reward is associated with a second provider item in the list of second provider items.

In a further form, the method includes adding the user selection of the item to a list of potential prize items, the list of potential prize items being associated with the user.

In one example, the present invention provides a method for generating a list of potential prize items, the method including the steps of, in a processing system: receiving a selection of a potential prize item from a user, the user having been provided item information associated with a respective plurality of potential prize items; and, adding the selection of the potential prize item to the list of potential prize items, the list of potential prize items being associated with the user.

The method can further include providing one or more competition questions, the user winning one or more prize items by answering the one or more questions.

Receiving the selection of a potential prize item can include receiving the selection from the user having scanned the item information from a code associated with the item. The code can be a unique code placed on the item by a provider of the item.

The provider can be a retailer and the user physically visits the retailer to be provided the item information. Further, the method can include receiving the selection of potential prize items from a plurality of users, where each of the plurality of users have an associated user account, and adding the selection of potential prize items, adds the prize item to the list of potential prize items associated with the associated user account.

The user account can be any one or a combination of: a user account for an individual; a user account for a team; and, a user account for a group of user.

The user can receive advertising associated with the potential prize item or a provider of the potential prize item.

The present invention can also provide a system for generating a list of potential prize items, the system including a processing system, the processing system being configured to: receive a selection of a potential prize item from a user, the user having been provided item information associated with a respective plurality of potential prize items; and, add the selection of the potential prize item to the list of potential prize items, the list of potential prize items being associated with the user.

The present invention can also provide a method for providing a location notification associated with a selected item, the method including, in a processing system: Receiving, a selection of an item from a user; Determining location information associated with the selection; Receiving user location information; Comparing the user location information to the location information associated with the selected item; and, Providing the location notification.

The processing system can be a mobile device, the processing system being configured to receive the location notification when mobile. The location notification can include any one or a combination of directions to the selected item; a map showing a route to the selected item; and, proximity information to the selected item.

The selected item can be a product and the user receives directions to a retailer of the product.

The present invention can also provide a system for providing a location notification associated with a selected item, the system including, a processing system, the processing system being configured to: Receive a selection of an item from a user; Determine location information associated with the selection; Receive user location information; Compare the user location information to the location information associated with the selected item; and, Provide the location notification.

The present invention can also provide a method for associating a user with a provider item, the method including the steps of, in a processing system: Receiving provider information, associated with a provider; Generating one or more unique codes associated with respective one or more provider items; Receiving one or more unique codes from the user, the user having scanned the one or more unique codes; and, entering the respective one or more provider items associated with the one or more unique codes into a user account associated with the user.

The provider information can include registration of a retailer. The one or more provider items can include one or more products, the unique codes being placed on the one or more products. The unique codes can be specific for a competition.

Scanning the unique code can enter competition data for the user into the competition. The user can use a customised scanner, the customised scanner being customised for the competition.

The method can further include adding the one or more provider items to a list of selected items, the list being associated with the user.

The method can further include generating customised advertising information for the user, the advertising information being associated with any one or a combination of: the provider; and, the one or more provider items;

The present invention can also provide a system for associating a user with a provider item, the system including a processing system, the processing system being configured to: receive provider information, associated with a provider; generate one or more unique codes associated with respective one or more provider items; receive one or more unique codes from the user, the user having scanned the one or more unique codes; and, enter the respective one or more provider items associated with the one or more unique codes into a user account associated with the user.

The present invention can also provide a method for generating customised advertising associated with a provider, the method including, in a processing system: receiving user information, the user information being associated with an interaction of the user with a provider; and, generating customised advertising related to the interaction of the user with the provider.

The interaction can include the user physically visiting the provider. The method can include generating the customised advertising on a pre-determined location on a website, the website being accessible by the user. The user information can include a unique code scanned by the user of a product of the provider. Generating the customised advertising can include generating advertising in relation to the product scanned by the user.

The present invention further can include a system for generating customised advertising associated with a provider, the method including, in a processing system: receive user information, the user information being associated with an interaction of the user with a provider; and, generate customised advertising related to the interaction of the user with the provider.

The present invention can also provide a method for generating a pool of user points, associated with a user, the pool of user points being for limited use by the user, the method including the steps of, in a processing system: receiving notification of one or more points accumulated by the user; adding the one or more points to a pool of user points; and, limiting the use of the pool of points by the user by pre-determining one or more points in the pool for a specific cause.

The method can include redeeming the points for monetary contribution to a charitable cause. In one example, pre-determining the one or more points of the pool can include any one or a combination of receiving a selection of a cause from the user; and, providing a default selection of a cause.

The pool of user points can include monetary value.

The present invention can further provide a system for generating a pool of user points, associated with the user, the pool of user points being for limited use by the user, the method including the steps of, in a processing system: receive notification of one or more points accumulated by the user; add the one or more points to a pool of user points; and, limit the use of the pool of points by the user by pre-determining one or more points in the pool for a specific cause.

The present invention can include a method for generating a suggestion, the method including the steps of, in a processing system: receiving user information related to a user; receiving updated location information of the user; and, generating a suggestion associated with the user information and the updated location information.

The user information can include: current location information; and, a user favourite; and, wherein generating the suggestion includes generating a new user favourite based on the updated location information.

The method can further include: comparing the user information to other information in a store, the other information being associated with the updated location information; and, generating the suggestion based on the comparison.

The user favourite can include any one or a combination of the user's: eating choice; drinking choice; reading choice; entertainment choice; medication choice; lifestyle choice; and, travelling choice.

The user can share the user information with other users. The user can receive suggestions from other users. The new user favourite can be similar to or identical to the user favourite. The method can further include generating directions to the new user favourite.

The present invention can also provide a system for generating a suggestion, the system including a processing system being configured to: receive user information related to a user; receive updated location information of the user; and, generate a suggestion associated with the user information and the updated location information.

There is provided herein many methods and systems, and it will be appreciated that the methods and systems can be any one or a combination of the examples, forms and features described.

### BRIEF DESCRIPTION OF THE DRAWINGS

An embodiment or embodiments of the present invention will now be described, by way of example only, with reference to the accompanying drawings, in which:

FIGS. 1A to 4D are flow diagrams of example methods/processes which may be implemented in accordance with the present invention;

FIGS. 5 and 7 are a functional block diagram of an example processing system that can be used in an implantation of the methods/processes of FIGS. 1A to 4C;

FIG. 6 is an example network infrastructure which can be used in by processes/methods of FIGS. 1A to 4D;

FIGS. 8A and 8B are flow diagrams of example methods/processes which may be implemented in accordance with the present invention;

FIG. 8C is another flow diagram of an example method/process of the present invention;

FIGS. 9 to 11 are further examples of flow diagrams of example methods/processes which may be implemented in accordance with the present invention; and,

FIG. 12 is a schematic of an example user mobile device such as a smart phone.

### DETAILED DESCRIPTION OF THE EMBODIMENT OR EMBODIMENTS

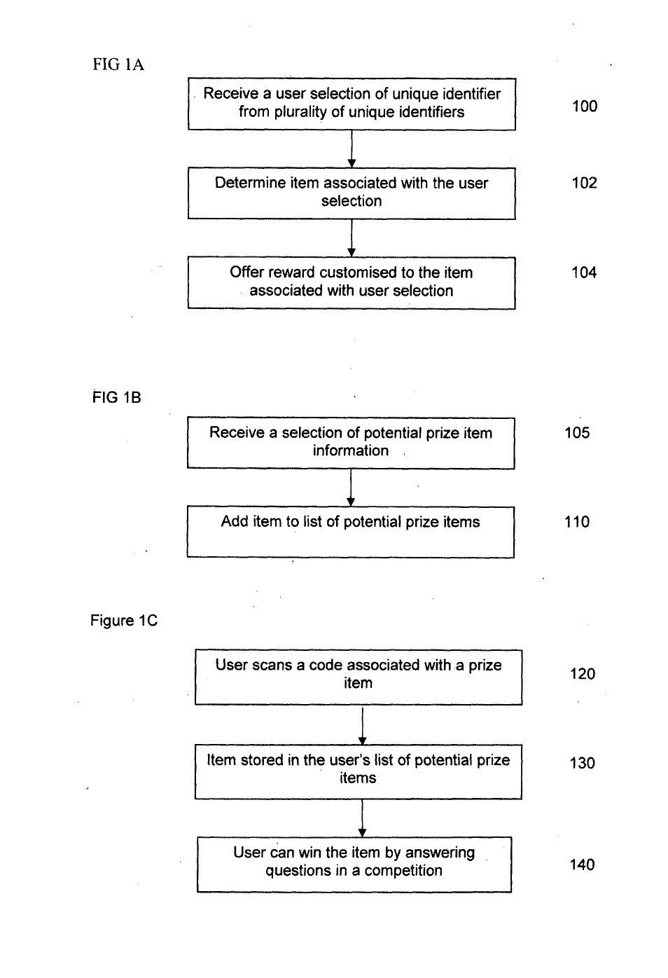

According to one example, there is provided herein a method of offering a reward customised to a user, as shown in FIG. 1A.

In this particular example, at step 100, a user selection of a unique identifier can be received. The unique identifier is typically received from a plurality of unique identifiers which are associated with a respective plurality of items from one or more first providers. At step 102, the item associated with the user selection is determined, and at step 104 a reward is offered to the user, where the reward is customised to the item associated with the user selection.

Thus, for example, the reward can include a special offer by the one or more first providers, a chance to win the item and or a special offer by one or more second providers. Examples of customisation of particular rewards such as prize items are provided below.

Thus, the methods and systems described herein can include a plurality of providers which can provide a plurality of items which associated unique identifiers (or codes as described below). In one particular example, the method can include receiving a request from one or more first providers to connect to one or more second providers, receiving acceptance of the request from the one or more second providers and connecting the one or more first providers to one or more second providers.

Accordingly, the methods described herein can include receiving a list of first provider items from the one or more first providers and receiving a list of second provider items from the one or more second providers, such that when a user selects an item, the item is an item included in the list of first provider items and the reward is associated with a second provider item in the list of second provider items. Further, the user selection of the item can be added to a list of potential prize items, the list of potential prize items being associated with the user.

Thus, one or more retailers may be able to connect via the systems described herein and become associated business partners. Users selecting one item from one retailer, may then be able to receive a reward or information associated with another item from the first retailer's business partner. Accordingly, in one particular example, if a person purchases or sees a wedding ring at a jeweller, they may then receive information, discounts, offers, or even win their wedding cake from a baker which has formed a partnership, with the jeweller in respect of those particular items.

In a further example, there is provided herein a method for generating a list of prize items, as shown in FIG. 1B. In this particular method, step 105 includes receiving a selection of potential prize items from the user, and step 110 includes adding a selection of the potential prize items to a list of potential prize items. Thus in this example, the user may have been provided item information associated with a respective plurality of potential prize items and the list of potential prize items may also be associated with the user.

FIG. 1C shows that the user can scan a code associated with a prize item at step 120 and at step 130, the item is stored in the users list of potential prize items. At step 140, the user can win the item by answering questions in a competition.

Thus, the method can also include providing one or more competition questions where the user wins one or more prize items by answering the competition question(s). It would be appreciated that receiving a selection of potential prize items from the user can include receiving a selection from the user having scanned the item information from a code associated with the item. The code can be a unique code placed on the item by a provider of the item, who can also be registered with the competition.

Thus for example the provider can be a retailer, where the retailer provides a unique code on a product and the user can physically visit the retailer to be provided with the item information. This can be performed by the user by scanning the code that is provided on the product or item.

Notably, it will be appreciated by persons skilled in the art that the user does not necessarily have to physically visit the retailer but may also scan advertisements in printed articles or the like, or may receive the unique code via any form of electronic/digital advertising mediums.

The method can also include receiving the selection of potential prize items from a plurality of users where each of the users has an associated user account and adding the selection of potential prize items to the list of potential prize items associated with the associated user account. Thus, a plurality of users each having their own accounts can collect their own list of potential prize items.

It will further be appreciated that the user account can be owned by an individual or a team of users or a group of users who are partaking in the competition.

In a further example, the user can receive advertising associated with the potential prize item or a provider of the potential prize item. Thus, the advertising can be customised or directed towards the user after having scanned the prize item where the advertising can be displayed on a website that is regularly accessed by the user.

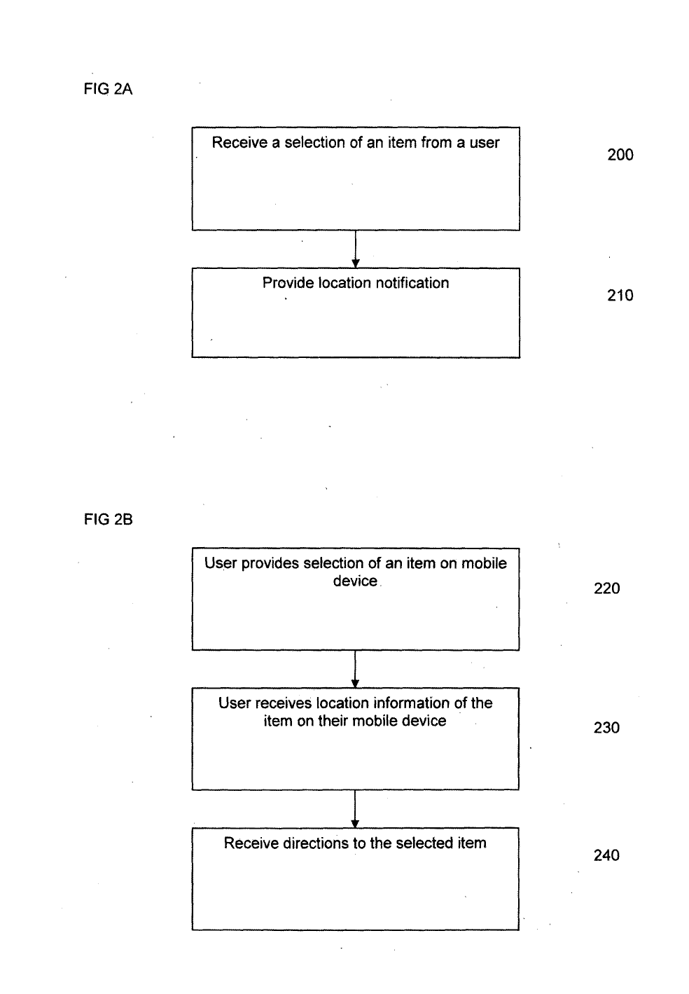

In a further example, there is provided herein a method for providing a location notification associated with the selected item. This example is shown in FIG. 2A. In FIG. 2A, at step 200, a selection of an item from the user can be received. At step 210 the user is then provided with a location notification. FIG. 2B shows that when the user provides a selection of an item at step 220 this is provided on a mobile device, such as a mobile telephone, computer, smart phone, or the like. The user can then receive location information of the item on the mobile device at step 230 and can then also receive directions to the selected item at step 240.

Thus, the method can include receiving a selection of an item from a user, determining location information associated with the selection, receiving user location information, comparing the user location information associated with the selected item and providing the location notification to the user accordingly. Thus, for example, a user may select a particular product the user likes and add the product to a list of their favourite products. The particular selection is then compared to known location information stored in the database. Once the user is walking past the product or is near the product, the user can be provided with a location notification in respect of the location of the product, notifying the user that he/she is close to one of their favourite products.

It will be appreciated that this can be provided when the user is mobile and thus can be provided on the user's mobile device.

The location notification that is provided to the user can be either a direction to the selected item, a map showing a route to the selected item or proximity information in relation to the selected item. Thus, for example, the proximity information may be that the user is getting warmer or nearer to the selected item and does not necessarily give exact location details of the selected item. Accordingly, the directions provided to the user may be directions to a retailer of the selected item, which can be a product which the retailer stores, and the user wishes to purchase.

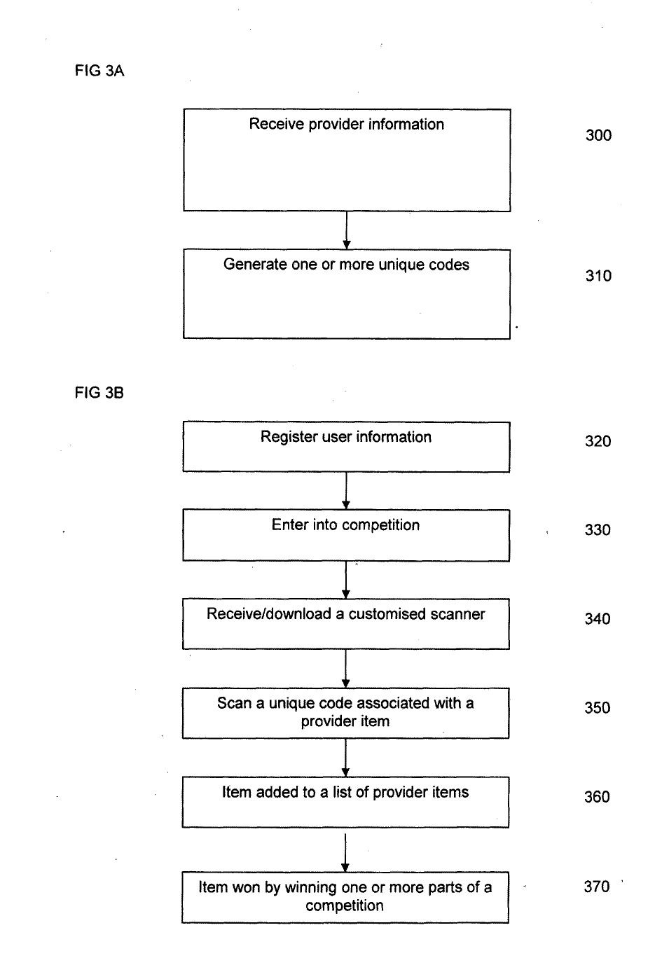

In yet a further example there is provided herein a method for associating a user with a provider item. This for example is shown in FIG. 3A. In FIG. 3A, at step 300 provided information is received and at step 310 one or more unique codes are generated. The unique codes are often associated with a respective one or more provider items.

The method can further include receiving the one or more unique codes from the user, where the user has scanned the one or more unique codes, and entering the respective one or more provider items associated with the one or more unique codes into a user account associated with the user, once the user has scanned the codes. The provider information can include registration of a retailer, where the retailer registers on a website to then be provided with unique codes for particular products.

The unique codes can then be placed on the one or more products of the retailer and can be specific for a competition. Scanning the unique codes by a user can enter competition data for the user into the competition. Thus, the competition data can include the fact that the user has scanned the code and has visited the particular retailer. In this particular example, the user can use a customised scanner which is customised for the competition.

Once the unique code is scanned, the one or more provider items can be added to a list of selected items which is associated with the particular user that scans the codes. Thus, the user may then receive customised advertising being associated either with the provider and/or the one or more provider items.

FIG. 3B shows an example where at step 320 the user may register the user information, at step 330, enter the competition, and at step 340 receive or download a customised scanner. At step 350, the user can then scan a unique code associated with a provider item. At step 360, the item is added to a list of provider items and at step 370, the item can be won by winning one or more parts of the competition.

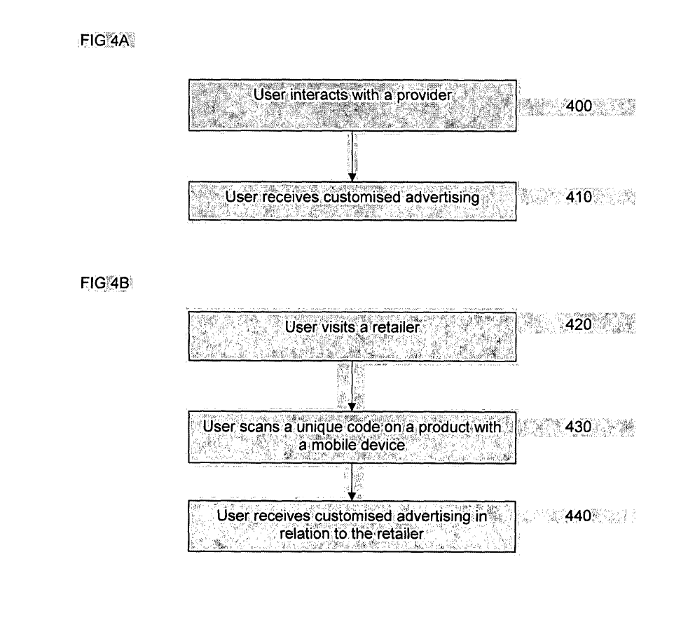

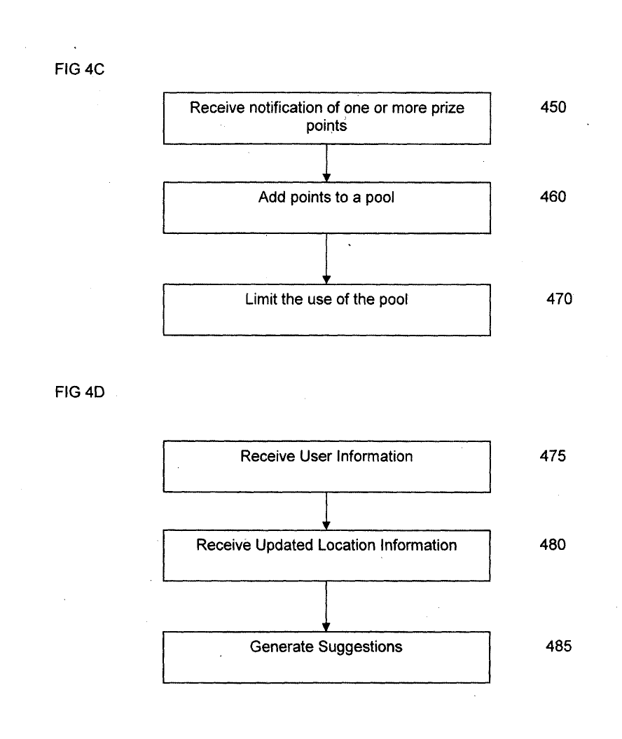

In yet a further example, a method for generating customised advertising associated with the provider is provided. This, for example, as shown in FIG. 4A includes at step 400 a user interacting with the provider. At step 410, the user receives customised advertising accordingly. Thus, user information can be received where user information is associated with the interaction of the user with the provider. Accordingly, customised advertising can be generated relating to the type of interaction of the user with the provider.

It will be appreciated that the particular interaction can include the user physically visiting the provider and can further include scanning one or more provider items. The method can also include generating customised provider advertising on a predetermined location on a website, when the website is accessible by the user.

Notably, the user information received can include a unique code scanned by the user of a product provider and the customised advertising can include generating advertising in relation to the products scanned by the user.

FIG. 4B shows that at step 420, a user can visit a retailer where at step 430, a user can scan a unique code on a product of the retailer with their mobile device. At step 440, the user can receive customised advertising in relation to the retailer or the products that have been scanned.

In yet a further example, a method for generating a pool of user points, associated with the user, where the pool of user points is for limited use by the user is described. In this example, as shown in FIG. 4C, a user receives notification of one or more points at step 450 where the points are added to a pool at step 460 and the pool is limited for use of the user at step 470. Thus, the method can include receiving notification of one or more points accumulated by the user, adding the one or more points to a pool of user points, and limiting the user of the pool of points by the user by predetermining one or more points in the pool for a specific cause.

Thus, the user may predetermine that the points are redeemed for contribution to a particular charitable cause. Predetermining the one or more points of the pool can include receiving a selection of the cause from the user and/or providing a default selection of the cause. Thus, the user is always limited to either the default selection of a cause or a Particular cause selected by the user.

In another example, a method for generating a suggestion is shown in FIG. 4D. In this example, the method including the steps of receiving user information related to a user at step 475, receiving updated location information of the user at step 480, and generating a suggestion associated with the user information and the updated location information at step 485.

Thus, the user information can include current location information (of the user), and a user favourite. This can be used to generate a suggestion that includes generating a new user favourite based on the updated location information. The user favourite can be anything related to the user, such as the user's eating and drinking choices (whether particular meals or a favourite restaurant), reading choices (such as books, magazines, or the like), entertainment choices (such as favourite movies, tv shows, etc.), medication choices (such as vitamins or antibiotics, etc,), lifestyle choices (can include activities such as bird-watching, rowing etc.), and travelling choices (such as favourite things to see on a trip or favourite places).

In a further example, the user can share the user information, including the user favourites with other users. Thus, the user may receive suggestions from other users. In yet a further example, the new user favourite which is suggested by the method/system described herein can be quite similar to or identical to the (original) user favourite, and the method can also include generating directions to the new user favourite.

Accordingly, in this particular example, the user may set up a user profile on a website or the like, and may then proceed to add various favourite items to the website. This can include the last place the user, visited, the user's favourite restaurant or meal, any current medication the user is using or any books the user is currently reading or has read in the past.

Thus, when the user changes locations (say for example, the user may travel or move to another city), the system can provide suggestions which are similar to or identical to the user's known favourites. For example, the system may note that the user likes a particular restaurant with a particular type of food and can then suggest another restaurant which is similar to the one that the user likes, in the new location. The system/method described herein can also direct the user to the new restaurant. Similarly, if the user has entered in current medication treatment, and then travels to another city, then the system/method can suggest where the user can find a pharmacy if they run out of their medication, or alternative treatments, etc.

Notably, in determining the new favourite, the system may compare to known elements in a store, database, or the like, where the information on similar products/services in different cities has been previously entered into the database. Thus, the process can also include comparing the user information to other information in a store, where the other information is associated with the updated location information, generating the suggestion based on the comparison.

It will be appreciated that the methods described herein (as shown for example in FIGS. 1A to 4D) can be provided by one or more devices or systems, in which the devices can include any hand held devices such as mobile telephones or mobile computing systems, smart phones, PDA's (personal digital assistants), portable music players, game consoles (including portable game consoles), controls, smart televisions (smart TVs), smart cameras, or the like.

In one particular example, the device includes a processing system an example of which is shown in FIG. 5. As shown, the example processing system 505 in FIG. 5 can include a processor 500, a memory device 501, one or more input/output devices 502/503 such as a keyboard/keypad and display, 503. The various components 500, 501, 502, and 503 can communicate with each other together by one ore more system buses 504 as shown.

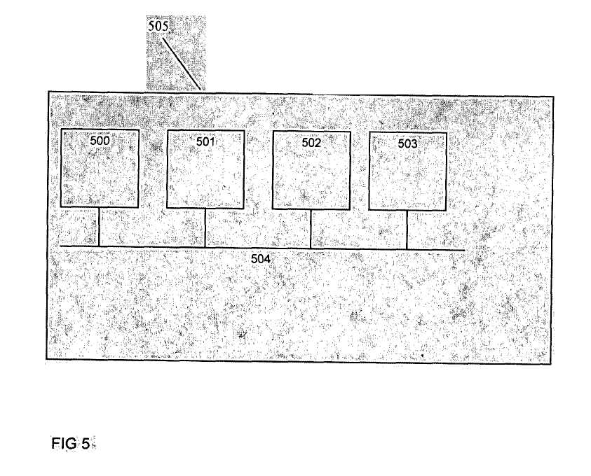

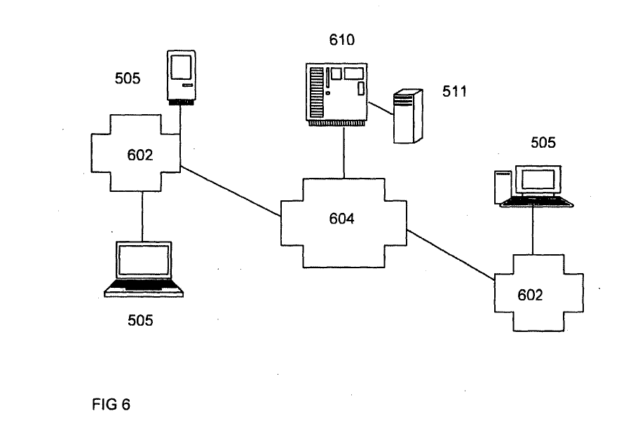

The device 505 can be coupled to a communication network, such as the Internet or the like, where examples of which include the communications network 602, 604 as shown in FIG. 6. Thus, the communication network 602, 604 can allow the device 505 to communication with the processing system 610 provided in a base station 601 via the communication network 602, 604.

Thus, in one example, the device 505 is a mobile phone that can be used by a user to access networks such as the Internet, and to give affect to any of the processes shown in FIGS. 1A to 4C. Accordingly, the process of FIG. 1A to FIG. 4C can be performed by using a distributed system an example of which will now be described in relation to FIG. 6

In this example, a base station 601 is connected to a number of end stations 505 (which can be user end stations) via a communications network 602 such as the Internet, and/or via a communication network 606 such as local area networks (LANs), or wide are networks (WANs). Thus, it will be appreciated that the LANs 604 may form an internal network at a specific location.

The base station 601 typically includes one or more processing systems 610, which can include one or more databases 611. In use, the process system 610 can be configured to allow the users of the device 505 to access particular information/data stored in the database 611, such as accessing a website, adding or amending user information, or the like.

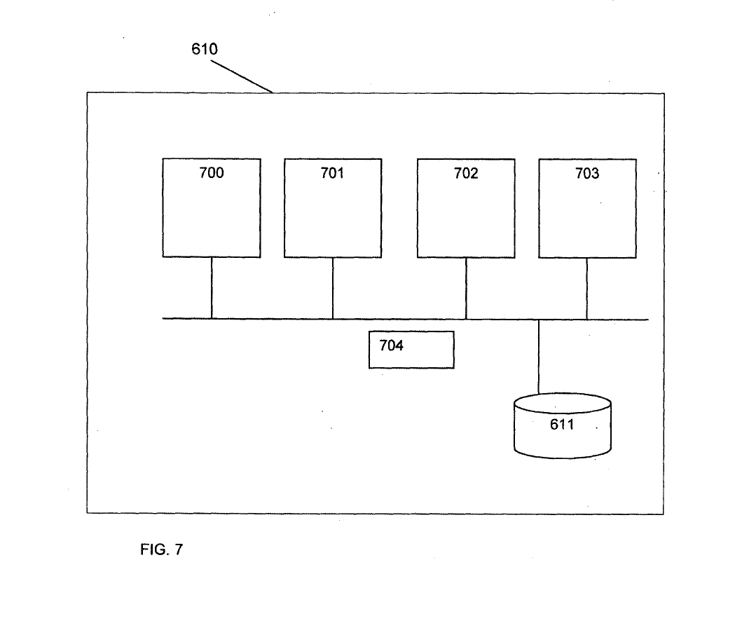

Accordingly, any form of suitable processing system 610 may be used. An example is shown in FIG. 7. In this example, the processing system 610 includes a processor 700, a memory device 701, an input output device 702 such as a keyboard and display and an external interface 703 connected by one ore more system buses 704 as shown. Accordingly, it will be appreciated that the processing system 610 may be formed from any suitable processing system as described in reference to FIG. 5.

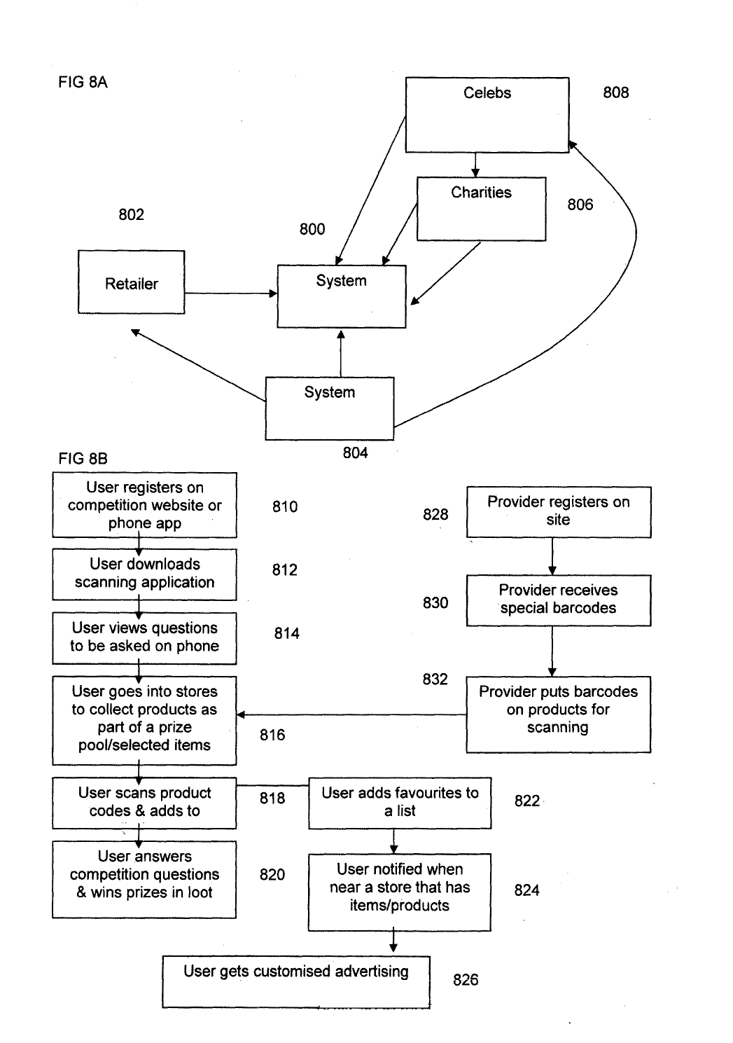

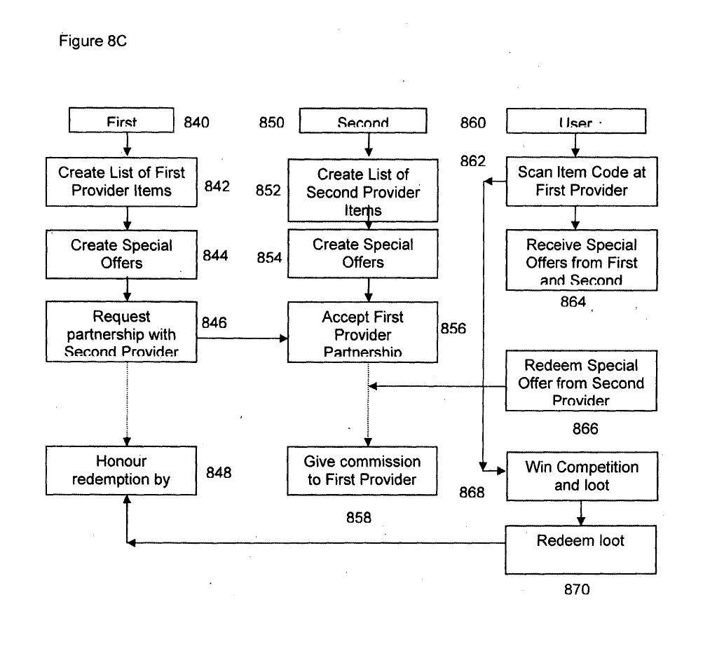

As previously discussed, the methods described herein can be implemented on a processing system of FIGS. 5 and 7 as well as the intemet or network connection as shown in FIG. 6. FIG. 8A shows how the different parties may be, connected. Thus, a system such as the processing system of 610 can be provided at 800. All the various users can be connected in one way or another to the system 800. Thus, a retailer 802 can communicate with the system 800, a user 804 can communicate with the system 800 (where the user 804 can be a competition participant), charities 806 and celebrities 808 can also communicate with the system. The celebrities can also communicate with the charities as can the user with the charities and the celebrities in order to partake in the competition. This is further described in FIG. 8B.

In FIG. 8B, a user may register on a competition website or mobile phone devise once the mobile application is downloaded at step 810. At step 812, the user can download or enable a scanning application (as part of the mobile application download) and at step 814, the user can view questions which are to be answered in the competition. At step 816 the user can then go into stores to collect products as part of a prize pool or selected items. In parallel, a provider or a retailer can register onto the website at step 828. At step 830, the provider can receive specialised/unique barcodes to then put onto products for scanning by users of the competition at step 832.

At step 818 the user scans product codes by visiting the retailer. Scanning of these codes, adds the respected products to a list or a loot. You will notice that at step 822 the user can also add favourite products which they would like to win to their user list. At step 824 if a user is walking by the product, the user can be notified when they are near a store that has one or their favourite items or products. At the next step 826 the user can receive customised advertising in accordance with the scanned product or retailer.

In this particular example, the user participates in the competition and proceeds to answer various questions. At certain stages, the user may then win prizes they have selected in their loot. In one particular example, the user can nominate to donate to a particular charity. Alternatively, the user may include as a prize, a meeting with their favourite celebrity, or the like.

FIG. 8C shows an example of the system/method described herein with three different types of users—a first provider at 840 (otherwise referred to herein as a business or retail establishment), a second provider at 850 (again referred to herein as a business or retail establishment) and a user at 860, which is typically a competitor in a competition.

Thus, the system/method described herein can include a first provider at 840 creating a list of first provider items (that is a list of loot which can be scanned by users 860 of the system). At step 844 the first provider 840 can create special offers which can be provided to users 860 of the system. The first provider can also request a partnership or a link with a second provider at step 846, which can be accepted by the second provider at 856. At step 848, the first provider honours any redemption of prizes (that is provider or loot items) which the user has won.

The second provider at step 850 can also create a list of second provider items at 852 and create special offers associated with at least one or more of the second provider items as step 854. As shown in FIG. 8C, the second provider can also give commission to the first provider if a user redeems a special offer from the second provider at step 866.

The user in the competition at 860 can scan item codes associated with loot items at the first provider at step 862. At step 864 the user can receive special offers from first and second providers and redeem these offers accordingly at step 866 and 870, depending on whether or not they are required to win a competition or complete sections of a competition at step 868.

It will be appreciated that the first provider, second provider, and competition user can perforrt any of the steps in FIG. 8C with any suitable processing system such as a desktop, laptop, tablet device, or, mobile telecommunication device. The data which is accessed by each user can be stored in a data store or in a data cloud, and accessed by the system accordingly.

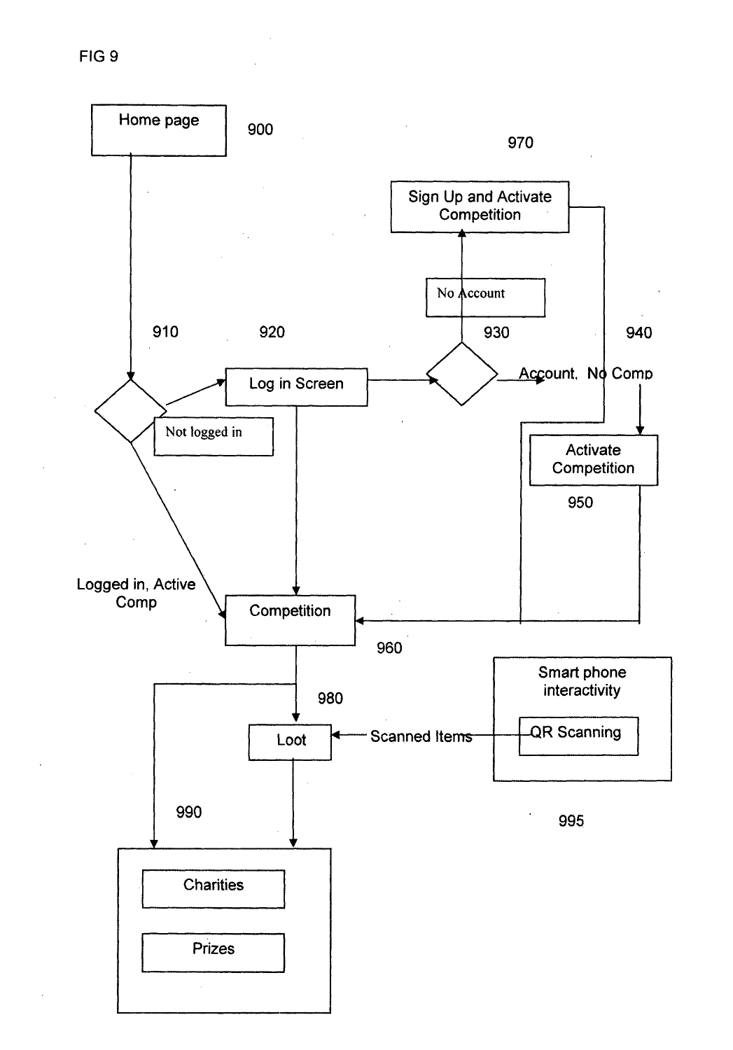

FIG. 9 shows another example of a flowchart for various interactive sessions between the different parties of FIG. 8A.

At step 900, there is provided a home page where at step 910 a user is provided with a login screen. If the user is not logged in then at step 920 it is determined whether or not they have an account at step 930. If the user does not have an account then at step 970 they sign up and activate the competition and their account.

At step 940, if the user has an account but they are not registered to activate the competition then at step 950 they can activate the competition and enter the competition at step 960. You will note that step 920 when the user logs in, and they have an account and are activated in the competition, they can go straight onto step 960. At step 980 the user has access to the loot which can be added with scanned or selected items from step 995, which in this particular example, is a smart phone. The smart phone can allow a user to have a customised scanner therein which is a customised QR (Quick Response code) scanner or the like, in order to scan various products and add them to their loot in the competition. A user may also be able to navigate various pages within the website or the mobile phone application such as charities and prizes at step 990.

Notably, it will be appreciated that the unique identifier (or code) can be provided on or near the item and can include any unique identifier which can be used to identify a specific item (which is typically associated with a specific provider). The code can include barcodes, images, or any other identifier.

Further, it will also be appreciated that the provider generate one or more unique codes specific to the provider and the item they wish to identify. In one particular example, the provider may, generate the codes via a webpage interface connected to the system/method described herein. Notably, as the provider has the ability to generate unique codes, the codes generated and associated items can be tracked and the data generated by the generation of the codes by the provider and scanning of the codes by the user can be mined for advertising purposes.

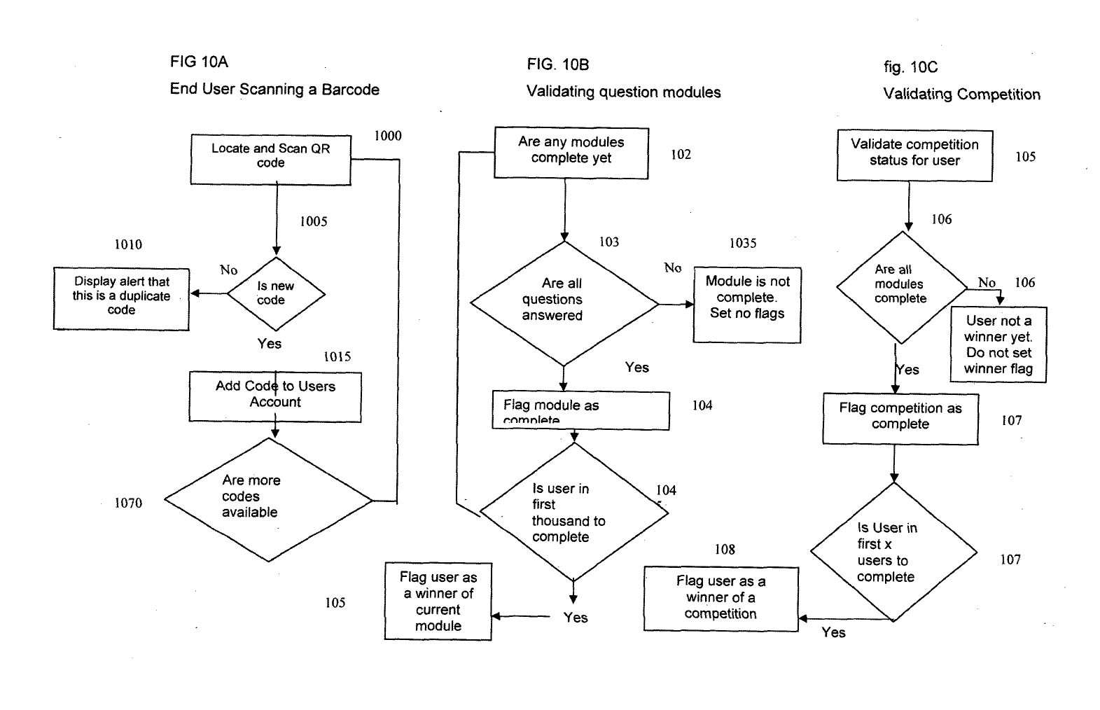

Further examples of the user's interaction are shown in FIGS. 10A to 10C.

In particular, the user scanning a barcode is shown in FIG. 10A where at step 1000 the user can locate and scan a QR code. At step 1005 it is determined whether this is a new code. If this is a new code, then at step 1015 the code is added to the user's account and if there are more codes available, at step 1020 the process goes back to step 1000. If the code is not a new code, then at step 1010, an alert will display that this is a duplicate code.

FIG. 10B shows an example process of validating question modules for a user, where the user is answering questions in the competition. In this particular example, at step 1025 it looks to whether any modules have been completed. If all the questions have been answered at step 1030 the process continues to step 1040 where a flag is raised that the module is complete. In this particular example, if the user is in the first 1000 to complete the module, then at step 1045 a flag is raised at step 1050 that the user is a winner of the current module. If the user is not within the first 1000 then it goes back to step 1025. If the modules are not complete then step 1035 is triggered.

FIG. 10C shows a process for validating the competition. At step 1055 the validation competition process can start which then determines whether all modules have been completed at step 1060. If not, then the user does not win the competition at step 1065. If the modules are complete then the process moves to 1070 where a flag is raised that the competition is complete, and at step 1075, it is determined whether the user is the first in a pre-determined number of users to complete the competition. If so, then the process moves to step 1080 where a flag is raised that the user is the winner of the competition.

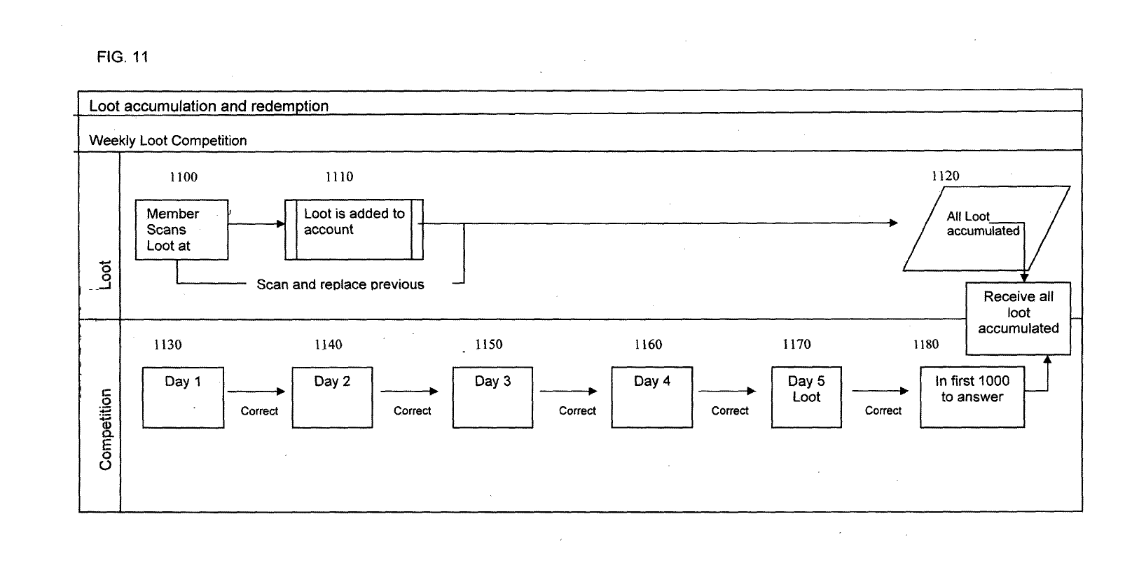

FIG. 11 shows that there can be processors herein which run simultaneously. Thus, at step 1100 a user scans and loots at a particular venue and the loot is added to their account at step 1110. Notably, this can be recursive where the scanning can replace previous items. A process then continues as to whether or the loot has accumulated at step 1120.

The competition can run over several days as shown in steps 1130 to 1170. In this particular example, the competition is run over five days and if the user answers particular questions on each of those days correctly, then the user can move onto the next stage of the competition, where at step 1170, the user can win a prize in their loot if they have answered the questions correctly. In this particular example, at step 1180 they have to be in the first 1000 users to answer the questions correctly for them to receive all of their loot accumulated.

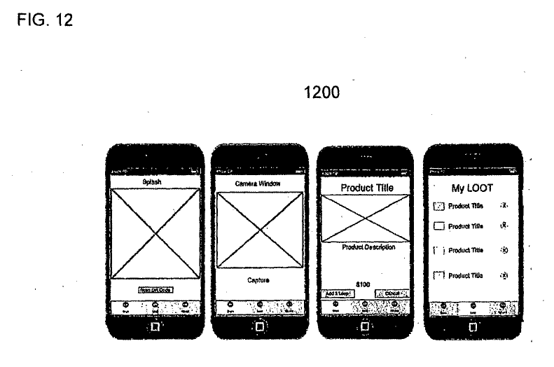

FIG. 12 shows an example of a user's smart phone 1200 which can be used in the process of the competition. The smart phone can be used in the form of an application or software on the phone that allows a user to add selected items to their loot or prize pool.

According to a further example, there is provided herein an online competition website to help promote charities, or the like.

The overall system can include:
Competition Website;
Mobile Application (iPhone and Android)
Retailer secure area (update products retailers would like to make available);
Charity area to allow celebrities related to charities to update their profile with what they can do for the competition;
Online video presentations, or the like. Competition Website

The competition website can include a number of areas allowing the end user to participate in the competition. The following sections outline some components of the website.

Sign Up/Sign in

In this particular example, users are required to sign-up for an account to be able to participate in the competition. Once signed up, they will be able to sign in to the site and participate.

Competition Panel

The competition panel can provide on the screen a series of panels that represent each day of the competition. Each day the user can be able to solve one of these panels. Completing a panel can partially reveal a QR code which can be scanned and can then take the user to a page allowing them to enter for the overall prize.

On entry to the site all panels with the exception of the first can be disabled and not allow the user to click on them. Thus, in this example, the user must answer question in the first panel correctly, before being allowed to proceed to the next panel.

When a user clicks on one of these panels, they will be taken to a page on the celebrity representing that particular panel. On this page there may be some biography info on the celebrity along with up to 3 questions configured in the admin system. Completing these questions correctly can result in that panel being rotated to reveal part of a QR code.

In this example, every fifth panel on this page can be a dot or make list panel that if answered and the user is in the first 1,000 (or otherwise defined) users to answer this panel correctly they can win whatever is in their loot.

Following the completion of all panels the full QR code can be revealed for scanning on a mobile device enabling entry into the final competition.

### Question Page

In one example, there is provided a question page, which can display relevant information about the celebrity associated with the panel. This will also include up to three questions that must be answered by the user in order to reveal what's behind the panel. This can appear in the form of a single answer question or as multiple choice questions.

Notably, the information on this page can be managed by the associated Charity or the celebrity themselves.

### Loot

In one example, users can collect prizes into their lists or loots by using their smart phone and installing an application on their phone and going to participating outlets and scanning QR codes (or unique and customised codes) on products.

As the products are scanned the users profile can be updated online so they are able to view the contents of their loot online or on the mobile device.

In one particular example, every week the loot stored by a user can be cleared and the user needs to go and scan more in order to be eligible to win anything after that particular week.

In order to win the items in their loot, the user must answer all questions correctly for the week, revealing all panels and having just the one loot label remaining to solve. In one example, if they are within the first 1,000 users to complete all panels for the week they win their loot.

### Mobile Applications

The mobile application can be used for the user to be able to scan their loot into their profile. The user may first need to enter their account details which may be stored rather than having to enter them all of the time.

The user may then be able to view all of their loot/list of items which they have scanned via the scanning application. A countdown timer can also be shown on the loot listing indicating how long until it may be cleared.

Further, a map may be provided within the user's application which displays locations within the area that have their loot/items available for scanning. This can allow users to locate the retailers without the retailer having to promote their location.

Example of a Retailer Secure Area:

There is provided herein, an area which can allow retailers to sign up to the site in order to be able to upload items available to be scanned.

This feature may require approval by a system representative to ensure all products being promoted are of an appropriate nature and not going to damage the reputation of the site.

The retailer can provide the following information:
Retailer name;
Location;
Product details (multiple);
Product Name;
Product Image.

Following the setup of each product they may be able to download a system generated QR code (following approval of the product) to display in their store for users to come in and scan. Thus the system may generate a unique QR code for each item.

### Celebrity Self-Management

There is also provided on the website an area which can enable celebrities to login (details provided to them by their related charity) and update profile information as well as entering into the system what they're prepared to offer up personally to the site which can be won by a user.

The list of celebrities in this section can be used to populate a feature on the competition site where the users can browse the list of celebrities associated with the site and add what the celebrity is offering to their loot or list of items.

### Administration System

The system described herein can also include an administration system which can have the following:
Competition stats;
Account management (competition participants, competition retailers, competition administration, retailers and charities/celebrities.)

### Further Examples

Provided below is, a particular example of an implementation of the system/methods described herein.

Thus, according to one particular example, a user of the system can be a competitor in a competition. They can use a mobile telecommunication device, mobile tablet, or the like to:
1. Find loot: Which shows the user a map with loot that is near to them based on geographical position location services. As the user zooms out of the map, more loot appears by pins dropping on to the map. By clicking on a pin more information is revealed about the loot, including value, provider and a brief description. The user then attends the location of the loot they are interested in winning.
2. Scan Loot: When a user is physically at a retailer/provider of the loot, they can select the scan loot option on their device which allows them to scan loot. If the loot is not already scanned, the user has the option to add the loot to their collection. It then appears in the user's My Loot
3. My Loot: This shows a list of all loot that the user has scanned and added to their profile. They can view the details for the loot here. There is also a clear visual indicator in the list view of loot they have won. These items will be at the top of the list. Once loot that has been won, the details screen will have a claim loot option and instructions on where to go to claim the won loot
4. Claim Loot: The user can attend the location to claim loot and scan a QR code provided by the retailer. Once claimed, the loot will disappear from the user's loot list.
5. Special Offers: When a user scans loot, any special offers created by the retailer or their a second provider/retailer in the first retailer's connections can be given to the user. These special offers can have a limited time to be redeemed.
6. Redeeming: In one particular example, redeeming of special offers can be the same as redeeming loot. The user attends the location specified in the details of the special offer, scans a QR code, enters the amount spent and confirms the redemption.
7. Play to Win: Play to win allows the user to participate in a competition. Typically, for a weekly competition, questions are provided day by day and only the current and previous weeks and question are available. Daily sponsored prizes are available to be won. Weekly loot is won at the last day of the week, typically being Friday. Questions become available at a specific time (set in the admin interface at the competition level) on their specified day. The questions are typically multiple choice and a user can answer as many times as they wish until they get the correct answer.
8. A Player wins loot if they are in the first fastest predetermined number of people to answer correctly. The predetermined number can be determined for each competition at a global level and applied to all Weeks. The first winner wins all the loot they have scanned if it is available, then the next winner. In one particular example, not all winners typically win all their loot as each loot item has a set number that is available for a competition.

According to one particular example, providers/retailers/businesses can register on a website such that they can manage their offerings and partnerships with other providers. Thus, for example, when logged into their account on the website, the providers can have access to the following options:
1. Home: A list of loot that has been won, who has won it and if it has been redeemed can be accessed by the provider.
2. Profile: A provider can change their details as well as add locations of new stores. They can also generate QR codes for redemption of loot.
3. Loot: This screen displays a list of all loot the provider has created for access by competitors/users of the system.
4. A provider can add, change or remove loot. Typically, loot has a title, price, image, description, competition it is attached to and the quantity that is available to win.
5. According to one particular example, loot can only be attached to one competition. Loot can be set to only be available to scan during a specific time period during the competition.
6. Offers: This screen shows a list of offers that the provider has entered for access by users and or other providers of the system. New offers can be created, changed or deleted here. Typically, offers have a start and end date, title, description, tier (see example of Business Rules provided below), category, redeem code, commission amount and image.
7. Offers are redeemed by the competition user scanning the store unique QR code, accessible from the profile section.
8. The provider can also have access to see any offers that have been redeemed, if they were referred from other retailers, the value of the transaction, the commission and amount owed to the referring party.
9. Partners: A provider/retailer/business can invite other businesses to become Business to Business (B2B) partners. Thus a second provider can be selected from a search or a list. Providers can also accept invitations and delete partners. In one particular example, all a provider's special offers are available to an accepted partner and vice versa. The special offers can be allocated to a competition user when loot is scanned at either partner's retail location.

According to another further example, the system/method described herein can be accessed by administration users. Administration users are provided access to the system typically at the backend for security reasons as they have access to business's profile information and competition settings. Thus, in one example, once an administration user is logged in they can be provided access to the following options:

1. Manage Businesses: An administration user can create new businesses, change their information and delete them on this screen. Businesses typically have a name, industry type, region, first name and last name of nominated contact, password, location, phone number and email address.

2. Competitions: An administration user can create a new competition, change its details and delete it. Typically, competitions have a start and end date and region they are associated with. Each competition has questions associated with it. These are entered in order they are to appear on the days of the competition.

3. Offer Categories: On this screen an administration user can create new categories for special offers, change details of current ones and delete categories.

4. An administration user can generate competition statistics and analysis, for example, how many players each day, week, competition to date, and the like.

5. Administration users can manage the text and link image for any promotional material provided to various users of the system/method described herein.

According to one particular example, the system/method described herein can provide daily loot for winning by a competition user. The daily loot can be sponsored loot by a provider and is posted every day of the week. It is won by winning a daily quiz and typically no scanning is needed to win. In one example, the daily loot can be implemented as follows:
1. In one particular example, a competition user can access the system/method described herein with their mobile telecommunication device. The quiz associated with the completion can be accessed in its own “Daily Loot” section of an application implemented on the mobile device. Any loot won can appear in the My Loot section of the application. When a user navigates to the “Daily Loot” section the user can see what and when loot is to be won Next, Currently and the last 7 days. Each loot item can have the standard loot details page, with a section for a sponsor's logo. Only the current or next quiz are typically accessible. If the next quiz isn't active yet, a countdown will be displayed.
2. Daily Loot is won based on the first predetermined number people to answer a question on the mobile, app. The question can be allocated randomly by the system from a pool of questions maintained by the system administrator. The question only appears at a certain time for a limited time window. As each question can be sponsored, a sponsor's logo can be provided with each question. Typically for the daily competition, the rest of the quiz can function in the same way as the weekly quiz, except the win is typically “instant” and generally not linked to answering all the questions by Friday.
3. Loot can be redeemed on a per prize win basis. The winners typically receive a notification on their mobile device that they have won. This can appear in the “My loot” section and can also include details on how to redeem the prize. These details will be content managed by the system administrator and users can provide personal details such as telephone numbers so that they can be contacted.
4. The successful winner/s and contact details can thus be displayed in the administration interface and a record can be generated of which user/s have won each daily loot prize.
5. Administrators can create daily loot items in a separate section of an administration interface. The loot items can be linked to an existing business and a logo or promotional image can be associated therewith. Typically, creation of daily loots can include populating the standard loot details, allocating the date and time the daily competition commences, a date and time it ends and details on how to redeem the loot.

According to one particular example, businesses (otherwise referred to herein as retailers/providers) can be authorised to access the system/method described herein by signing up on a website or the like. Once the business has requested access, an electronic mail or notification can be sent to the business to confirm access. In one particular example, the business may also be sent physical mail with an activation code, which the business can then use to log into the system and activate their account. Typically, the businesses are authenticated by an administration user prior to receiving the activation code. Thus, in one particular example, a business can be activated and authorised to access the system/method described herein through:
1. Creating and saving the business details
2. The system generates a .CSV file which is sent (emailed or other file transfer means) to a 3rd party for coding.
3. The .CSV format is hard coded and contains the dynamically generated information including user name, mailing address and a system generated activation code for the business.
4. Business user uses the activation code (typically a string of letters and numbers and unique to each business, which is also linked to the particular business in the system database/data store) by logging into the business administration interface and entering the activation code into a field on a home screen.

According to one particular example, the system/method described herein can allow a question within a competition to be sponsored. As discussed above, sponsorship can be controlled by an administration user where questions and competitions are managed. An administration user can select a question (if the question for the competition has been created) and add an image of a predetermined size and URL of the sponsor (which is typically a business) to the question. This image can then be displayed to competition users and work as a hyperlink in the answer panel of the selected question in both the website and the general loot competition as discussed herein. Adding an image and URL can also be available when the user is creating a question for the competition.

According to one particular example, the following business rules can be applied in respect of the loot, competition and special offers:
1. Loot
   a. Loot is allocated to one competition only
   b. Loot redemption can occur at any of a business's recorded locations
   c. Loot can only be awarded up to the amount of available loot set by a retailer
   d. Loot must be claimed within 14 days after it is won. This rule will be universal for all loot and hard coded into the system.
2. Competition
   a. Competitions are typically region based.
   b. Only one competition can be run at a time per region
   c. The first X amount of people that correctly answer all questions win all loot they have scanned, if it is still available. Weekly loot is allocated to the fastest user who answered the last question of the week correctly.

The following shows an example of special offers which can be provided by businesses to users of the system/method described herein:

The system described herein can provide an allocation of Tier 1 Special Offers. In one particular example, special offers are allocated to users when they scan a Loot QR code at a particular business. Once the user scans a Loot QR code they are typically given the Tier 1 special offer for that business and any other business that has a partnered link (that is second provider link) to the current business. Typically, a user can only ever be allocated a particular Tier 1 special offer once.

The system/method described herein can also allocate a Tier 2 Special Offer. In this particular example, at any time a user may only ever be allocated one Tier 2 special offer.

Thus, for example, upon redeeming a Tier 1 special offer the user can then be rewarded with a Tier 2 special offer. The Tier 2 special offer typically relates to the business that meets a criteria such as for example, the business was the source provider of the original deal (and not a referral, that is, not a second provider) or was the business the original loot code was scanned at that referred this deal. Accordingly, each time a user redeems their prize (or special offer), they can be allocated one more Tier 2 deal should one be available from either the business that referred the current deal or the business that offered the deal directly.

In one further particular example, redeeming offers by users can enable users to receive a higher value Tier 2 offer. Thus, for example, when redeeming an offer, the user may be prompted to scan a retailer's redemption QR code, enter the value of the transaction or submit a request. Following this, the system can then display on the user's device that the redemption was successful and update the database to reflect the redemption and allocate commissions between the business partners. Notably, redemptions can be visible to the offering businesses and the collection and disbursement of commissions can be handled outside of the system. The system can generate a report on offers redeemed and respective commissions.

In yet a further example, there is provided herein the ability for users to collect time and or location based loot. Thus, for example, the particular type of loot can appear on a map on the user's device at a specific location. When the user attends the location, they can scan, the loot item using the scan loot functionality described herein. The loot can then be added into the “My Loot” folder. Once selected, the user can receive details in respect of the loot and how they can play to win the loot.

In this particular example, the competition can include that not only does the user have to scan the item but the user may also attend a specified location at a specified time or time interval. The user must then scan a code at that particular location and during a time interval. The scanning of the code can then generate a location based quiz or questionnaire to be answered by the user in a predetermined time interval. The questionnaire is typically the same for all users at the particular location. The first predetermined number of users to answer, the questions or play the game correctly can win the loot.

It will be appreciated that this style of competition may be applied to events with large crowds such as sporting events at stadiums. Thus, the location of the code can be at the stadium, with the questionnaire being completed during the sporting activity (such as 90 minutes of football, or the like).

According to yet a further example, there can be a specific redemption process which can offer rewards (or prize items as described herein) to users of the system/method. In one particular example, a plurality of users are participating in the competition. For simplification, this example describes how two users—User One and User Two can potentially win a prize item (or any other reward). The table below (Table 1) provides an example of loot which each of the users (One and Two) have scanned into their loot:

TABLE 1

| User One | User Two |
|---|---|
| Item A | Item B |
| Item B | Item A |
| Item C | Item D |

In accordance with one example rule of the competition, both users have also answered all questions within the competition correctly. Thus, when it comes to winning the user selected items in their respective item lists as shown above, the win is typically dependent upon how many items are available for winning from the various provides and or the user who selected that particular item the fastest. Thus, in the example shown in Table 1 above, both users have scanned both Items A and B. If there is more than one Item A to win, then both users will win Item A. However, if there is only one Item A to win, then as User One was the first user to scan Item A, then User One will win Item A. The same logic will apply to Item B. Notably, in this example, as User One is the only user to scan Item C, then User One will be the only user to win Item C (and thus, it is not necessarily time dependent).

Thus, it will be appreciated that the above-described redemption of items can allow for various strategies to be applied by users of the competition so that they can try to maximise their chances of winning.

Notably, when setting up this type of loot, a business would need to provide to the system described herein the name, venue, address, time/date, and description of the event and the competition as well as a description and image of the loot which can be won. Notably, any business may create the competition and any other business can link loot to the competition. Furthermore, the questionnaire can be managed by an administration user.

It will further be appreciated that references to an “item” herein can include businesses providing services and or products and is not limited by the type of item.

It will further be appreciated that the system and method described herein can be implemented as a software competition or a game which a user can partake in by use of their handheld device, which can include and is not limited to a smart phone, tablet, smart camera, or the like.

Additionally, it will also be appreciated that the systems and methods described herein can provide numerous advantages, including but not limited to allowing users to consolidate products and services they are interested in and carry information in relation to those products and services on a mobile device. Furthermore, the system and method described herein works to provide more opportunities for businesses to interact (and for example, retailers to be visited) by potential customers and thus can bring providers and users together.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A method of offering a reward customized to a user, the method including the steps of, in a processing system:
a. receiving a user selection of a unique identifier from a plurality of unique identifiers associated with a respective plurality of items from one or more first providers;
b. determining the item associated with the user selection; and,
c. offering the reward customized to the item associated with the user selection.

2. The method of claim 1, wherein the reward includes any one or a combination of:
a. a special offer by the one or more first providers;
b. a chance to win the item; and,
c. a special offer by one or more second providers.

3. The method of claim 1, further comprising:
a. receiving a request from one or more first providers to connect to one or more second providers;
b. receiving acceptance of the request from the one or more second providers; and
c. connecting the one or more first providers to one or more second providers.

4. The method of claim 3, wherein the method further includes receiving a list of first provider items from the one or more first providers and receiving a list of second provider items from the one or more second providers, such that the user selection is an item included in the list of first provider items and the reward is associated with a second provider item in the list of second provider items.

5. The method of claim 1, further comprising adding the user selection of the item to a list of potenti

[symbol]

6. The method of claim 5, further providing one or more competition questions, the user winning one or more prize items by answering the one or more questions.

7. The method of claim 1, wherein receiving the user selection includes receiving the selection from the user having scanned the unique identifier associated with the item.

8. The method of claim 7, wherein the unique identifier is placed on the item by the one or more first providers of the item.

9. The method of claim 8, wherein the one or more first providers includes one or more retailers and the user physically visits one or more retailers to be provided unique identifier.

10. The method of claim 1, further comprising receiving a plurality of user selections from a plurality of users, where each of the plurality of users have an associated user account, and each of the plurality of user selections is added to a list of potential prize items associated with the associated user account.

11. The method of claim 10, wherein the user account can be any one or a combination of
a. a user account for an individual;
b. a user account for a team; and,
c. a user account for a group of user.

12. The method of claim 1, further comprising providing the user with advertising associated with the item or the one or more first providers.

13. The method of claim 1, further comprising:
a. Determining location information associated with the user selection;
b. Receiving user location information;
c. Comparing the user location information to the location information associated with the user selection; and
d. Providing the location notification.

14. The method of claim 13, wherein the processing system is a mobile device configured to receive the location notification when mobile.

15. The method of claim 13, wherein the location notification includes any one or a combination of:
a. directions to the user selection;
b. a map showing a route to the user selection; and,
c. proximity information to with the user selection.

16. The method of claim 13, wherein the item is a product and the user receives directions to a retailer of the product.

17. The method of claim 1, wherein the unique identifier is placed on the item.

18. The method of claim 1, wherein the unique identifiers are specific for a competition.

19. The method of claim 18, wherein the user scans the unique identifier for entering competition data for the user into the competition.

20. The method of claim 19, wherein the user uses a customized scanner, the customized scanner being customized for the competition.

21. The method of claim 1, further comprising:
a. generating a pool of user points associated with the user, the pool of user points being for limited use by the user;
b. receiving notification of one or more points accumulated by the user;
c. adding the one or more points to a pool of user points; and
d. limiting the use of the pool of points by the user by pre-determining one or more points in the pool for a specific cause.

22. The method of claim 21, further comprising redeeming the points for monetary contribution to a charitable cause.

23. The method of claim 21, wherein pre-determining the one or more points of the pool includes any one or a combination of:
a. receiving a selection of a cause from the user; and
b. providing a default selection of a cause.

24. The method of claim 21, wherein the pool of user points includes monetary value.

25. The method of claim 1, further comprising generating a suggestion by:
a. receiving user information related to the user,
b. receiving updated location information of the user; and
c. generating a suggestion associated with the user information and the updated location information.

26. The method of claim 25, wherein the user information includes:
a. current location information; and
b. a user favorite; and
wherein generating the suggestion includes generating a new user favorite based on the updated location information.

27. The method of claim 26, further comprising:
a. comparing the user information to other information in a store, the other information being associated with the updated location information; and
b. generating the suggestion based on the comparison.

28. The method of claim 26, wherein the user favorite includes any one or a combination of the user's:
a. eating choice;
b. drinking choice;
c. reading choice;
d. entertainment choice;
e. medication choice;
f. lifestyle choice; and
g. traveling choice.

29. The method of claim 25, wherein the user shares the user information with other users.

30. The method of claim 29, wherein the user receives suggestions from other users.

31. The method of claim 26, wherein the new user favorite is similar to or identical to the user favorite.

32. The method of claim 26, further comprising generating directions to the new user favorite.
